(19) United States
(12) Patent Application Publication
(10) Pub. No.: US 2024/0152769 A1
(43) Pub. Date: May 9, 2024

(54) AUTOMATIC FORECASTING USING META-LEARNING

(71) Applicant: ADOBE INC., SAN JOSE, CA (US)

(72) Inventors: Ryan A. Rossi, San Jose, CA (US); Kanak Mahadik, San Jose, CA (US); Mustafa Abdallah ElHosiny Abdallah, West Lafayette, IN (US); Sungchul Kim, San Jose, CA (US); Handong Zhao, Cupertino, CA (US)

(21) Appl. No.: 18/050,607

(22) Filed: Oct. 28, 2022

(51) Int. Cl. G06N 3/0985; G06Q 10/04

(52) U.S. Cl. CPC G06N 3/0985; G06Q 10/04

(57) ABSTRACT

Systems and methods for automatic forecasting are described. Embodiments of the present disclosure receive a time-series dataset; compute a time-series meta-feature vector based on the time-series dataset; generate a performance score for a forecasting model using a meta-learner machine learning model that takes the time-series meta-feature vector as input; select the forecasting model from a plurality of forecasting models based on the performance score; and generate predicted time-series data based on the time-series dataset using the selected forecasting model.

### BACKGROUND

The following relates generally to data processing, and more specifically to automatically selecting a forecasting model using meta-learning. Meta-learning is a technique for “learning about learning.” For example, in machine learning, a meta-learning model may learn about other deep learning models and their outputs. The meta-learning model can aggregate other model's results, and after a training phase, make accurate determinations for which model or results should be used in a downstream application.

Forecasting is the task of predicting future data. Time-series data is any data that can be represented as a sequence of values across time, such as data for weather patterns, stock prices, network usage, and the like. Different datasets and tasks use different time-series forecasting models. Typically, these models are constructed by experts, who determine the architecture and features most suited to the specific task. However, constructing a new model for every new dataset can be time consuming. Alternatively, many models may be trained and tested for a new dataset to determine the best performing model, but this is also a lengthy process as there are several time-series forecasting models available. There is a need in the art for automatically selecting the best time-series forecasting model for a time-series dataset from an arbitrary domain.

### SUMMARY

The present disclosure describes systems and methods for automatically choosing the best forecasting model for a new time-series dataset. Forecasting models are used to predict values that have not yet been observed. One forecasting model is better than another if it exhibits a higher performance; i.e., its forecasted values are closer to the observed values. The systems and methods described herein are configured to select the forecasting model with the highest predicted performance for a new dataset, without having to first train and evaluate every model in a model space on the new dataset. Embodiments of a meta-learning apparatus extract meta-features from the dataset, and then use a trained meta-learner machine learning model to select a forecasting model based on the meta-features.

In an offline training portion, performance data for many forecasting models as used on several datasets is input to the meta-learner machine learning model, along with meta-features from those datasets, allowing the meta-learner machine learning model to learn relationships between the meta-features and the forecasting models. In other words, the meta-learner machine learning model is trained on the performance of other models that used historical datasets and time-series meta-features of the historical datasets. Once trained, the meta-learner machine learning model is configured to extract meta-features from a new and unseen time-series dataset, and select a forecasting model with a high predicted performance based on the meta-features.

A method, apparatus, non-transitory computer readable medium, and system for automatic model selection using meta-learning are described. One or more aspects of the method, apparatus, non-transitory computer readable medium, and system include receiving a time-series dataset; computing a time-series meta-feature vector based on the time-series dataset; generating a performance score for a forecasting model using a meta-learner machine learning model that takes the time-series meta-feature vector as input; selecting the forecasting model from a plurality of forecasting models based on the performance score; and generating predicted time-series data based on the time-series dataset using the selected forecasting model.

A method, apparatus, non-transitory computer readable medium, and system for automatic model selection using meta-learning are described. One or more aspects of the method, apparatus, non-transitory computer readable medium, and system include identifying a training set comprising a plurality of time-series datasets, a plurality of forecasting models, and ground-truth performance data for the plurality of forecasting models applied to each of the plurality of time-series datasets; generating predicted performance data for the plurality of forecasting models applied to each of the plurality of time-series datasets using a meta-learner machine learning model; comparing the predicted performance data to the ground-truth performance data; and updating parameters of the meta-learner machine learning model based on the comparison.

An apparatus, system, and method for automatic model selection using meta-learning are described. One or more aspects of the apparatus, system, and method include a processor; a memory including instructions executable by the processor; a meta-feature extraction component configured to compute a plurality of meta-features based on a time-series dataset; and a meta-learner machine learning model configured to select a forecasting model from a plurality of forecasting models based on the time-series dataset.

### BRIEF DESCRIPTION OF THE DRAWINGS

FIG. 1 shows an example of a meta-learning system according to aspects of the present disclosure.

FIG. 2 shows an example of a meta-learning apparatus according to aspects of the present disclosure.

FIG. 3 shows an example of a pipeline for automatically selecting a forecast model according to aspects of the present disclosure.

FIG. 4 shows an example of meta-features from time-series data according to aspects of the present disclosure.

FIG. 5 shows an example of a method for providing a forecasting model with the highest predicted performance according to aspects of the present disclosure.

FIG. 6 shows an example of a method for predicting time-series data according to aspects of the present disclosure.

FIG. 7 shows an example of a method for selecting a forecasting model according to aspects of the present disclosure.

FIG. 8 shows an example of a method for generating predicted time-series data according to a forecasting model with hyperparameters according to aspects of the present disclosure.

FIG. 9 shows an example of a method for training a meta-learner machine learning model according to aspects of the present disclosure.

FIG. 10 shows an example of a method for training a meta-learner machine learning model based on a loss function according to aspects of the present disclosure.

### DETAILED DESCRIPTION

Time-series forecasting is the task of predicting future data, where the data is in the form of a time-series. Time-series data is data that can be represented in a sequence, and typically includes values at equally spaced time intervals. Examples of time-series data include stock market prices, weather and climate metrics, and resource usage.

Time-series forecasting at scale is used in a wide range of industrial domains such as cloud computing, supply chain, energy, and finance. Many available time-series forecasting solutions are built by experts, who spend time and effort to form custom models, engineer features, and tune hyperparameters (e.g., parameters that affect the model's processing pipeline, such as the number of layers in a deep neural network). These custom models typically cannot be applied to a wide variety of applications, as they have been specifically tuned for their intended application.

One way to choose the highest performing forecasting model would be to, given a new dataset, evaluate the performance of several different available models on the dataset and then select the best forecasting model for the dataset and the associated task. However, this approach is practically infeasible due to the amount of time to test all the models for each new task. In some cases, given the number of hyperparameters available to some models, thousands of unique models would need to be tested.

Another approach to selecting the best model is to use meta-learning. Meta-learning refers to methods and algorithms which are designed to learn from other learning models. For example, in the machine learning context, meta-learning models may learn about the metadata of other models, such as the algorithms and hyperparameters, and the relationship between the metadata and the outputs of the other models. The meta-learning model may then select the results from an aggregate response of the other models based on a predicted performance or accuracy. In other words, the meta-learning model may determine which results or models should be used after aggregating information from all of the models.

There exist some applications of meta-learning for time-series forecasting. Some systems use a generalized artificial neural network (ANN) and train it in two phases, first on a source dataset for coarse adjustments and then on a target dataset for fine adjustments. Other systems build multiple models for the task or domain, and test each of the models to determine the best model. However, these systems are based on prior domain knowledge. They are unable to select from other models outside the domain, such as a set of varied (i.e., heterogeneous) models.

Some other systems attempt to identify features about input data in order to classify the data. For example, they may classify the data as appropriate for one or more forecasting model classes. The systems can determine features from a set of data, but as they do not measure features or performances over different time windows, they are unable to infer the specific model to use, nor any associated hyperparameters for the model.

Embodiments of the present disclosure predict and select the highest performing model for a dataset without domain restrictions. The meta-learning apparatus learns the performances of multiple models designed for several different tasks, and learns relationships between these models' performances and “meta-features” of different datasets. The meta-features include time-series features such as trends, transform coefficients, regression metrics, and others, which apply to multiple different datasets. Accordingly, the meta-learning apparatus can select a forecasting model suited to any new time-series dataset by extracting and considering its meta-features. Additionally, some embodiments are configured to select multiple models for a given dataset, which can be applied across different time windows in the dataset for increased performance.

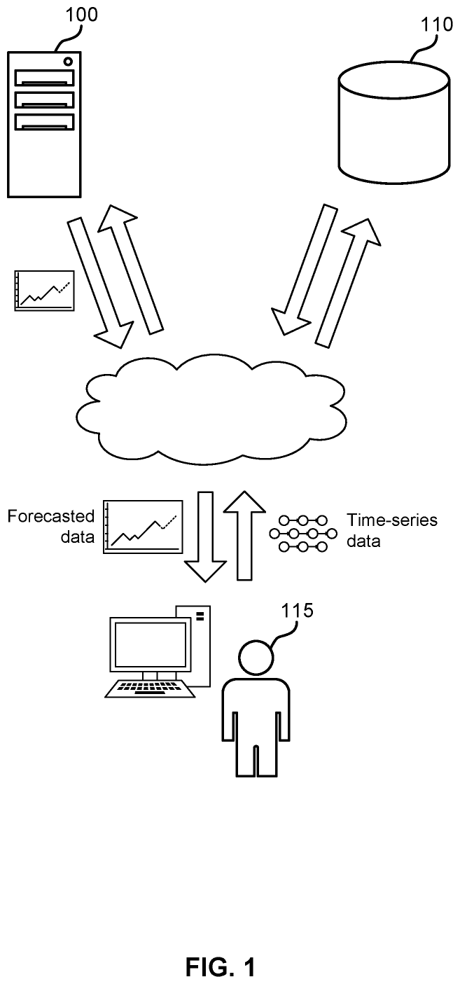

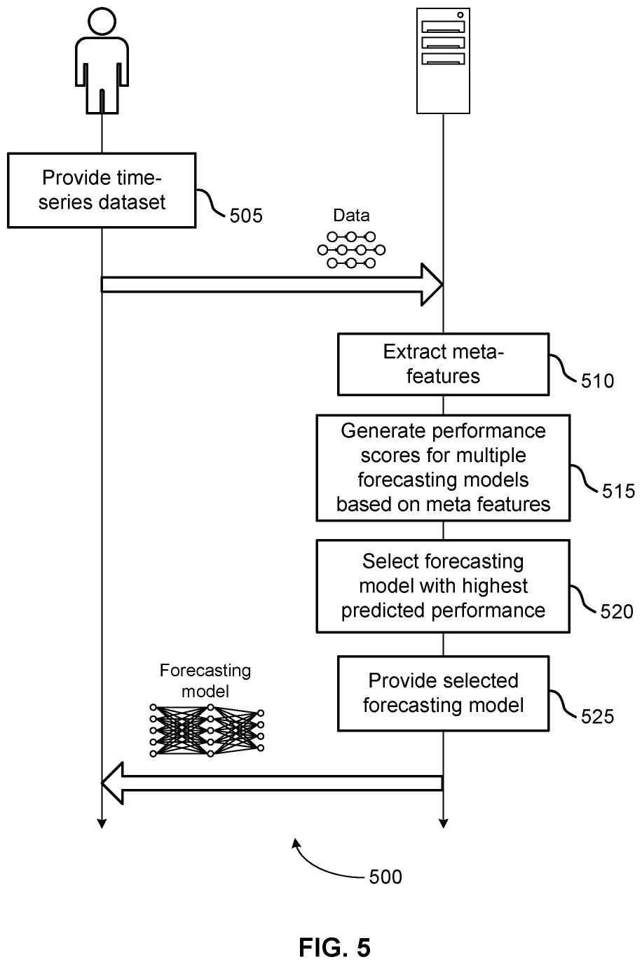

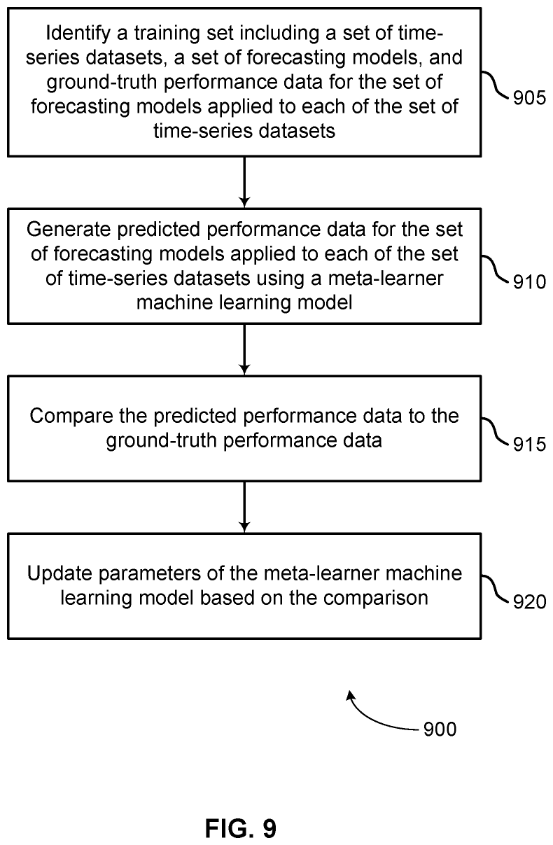

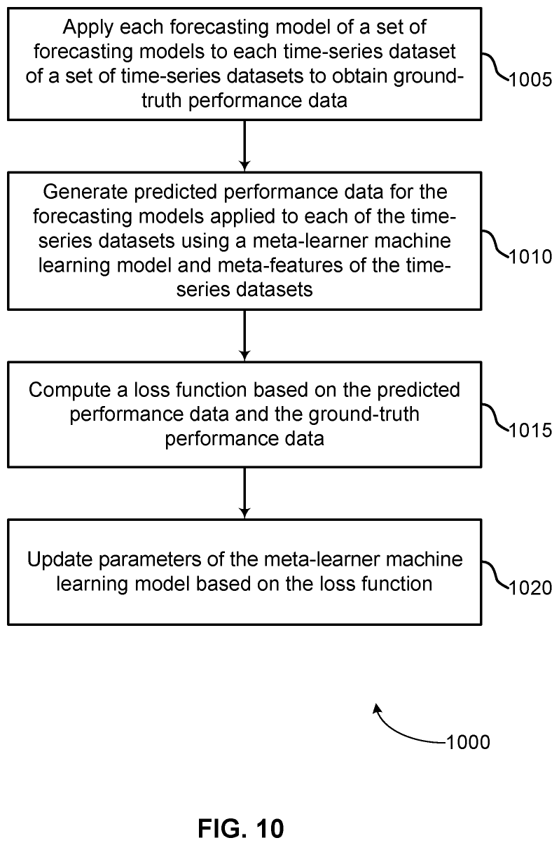

Details regarding the architecture of an example meta-learning apparatus and system, as well as example meta-features, are provided with reference to FIGS. 1-4. Examples of automatically selecting a forecasting model and providing predicted time-series data are provided with reference to FIGS. 5-8. Examples for training the meta-learning apparatus and the selected forecasting model are provided with reference to FIGS. 9-10.

### Meta-Learning System

An apparatus for automatic model selection using meta-learning is described. One or more aspects of the apparatus include a processor; a memory including instructions executable by the processor; a meta-feature extraction component configured to compute a plurality of meta-features based on a time-series dataset; and a meta-learner machine learning model configured to select a forecasting model from a plurality of forecasting models based on the time-series dataset.

Some examples of the apparatus, system, and method further include a training component configured to update parameters of the meta-learner machine learning model based on a loss function. In some aspects, the meta-learner machine learning model comprises a general meta-learner and a time-series meta-learner. Some embodiments of the time-series meta-learner include a long short-term memory (LSTM) model with LSTM cells. Some examples of the apparatus, system, and method further include a feature-embedding component configured to reduce a dimensionality of the plurality of meta-features.

FIG. 1 shows an example of a meta-learning system according to aspects of the present disclosure. The example shown includes meta-learning apparatus 100, network 105, database 110, and user 115.

Meta-learning apparatus 100 includes components configured to implement the methods and techniques described herein. In an example, meta-learning apparatus 100 receives a time-series dataset from user 115. Then, meta-learning apparatus 100 extracts meta-features from the time-series dataset, and, using a trained meta-learner machine learning model, determines a forecasting model for the input time-series dataset. In some embodiments, the forecasting model is selected based on its predicted performance with the dataset. In some embodiments, meta-learning apparatus 100 further trains the selected forecasting model, applies the dataset to it, generates forecasted data, and provides it to user 115.

Meta-learning apparatus 100 may be implemented on a server. According to various embodiments, one or more components of meta-learning apparatus 100 may be implemented on one or more servers connected by network 105. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

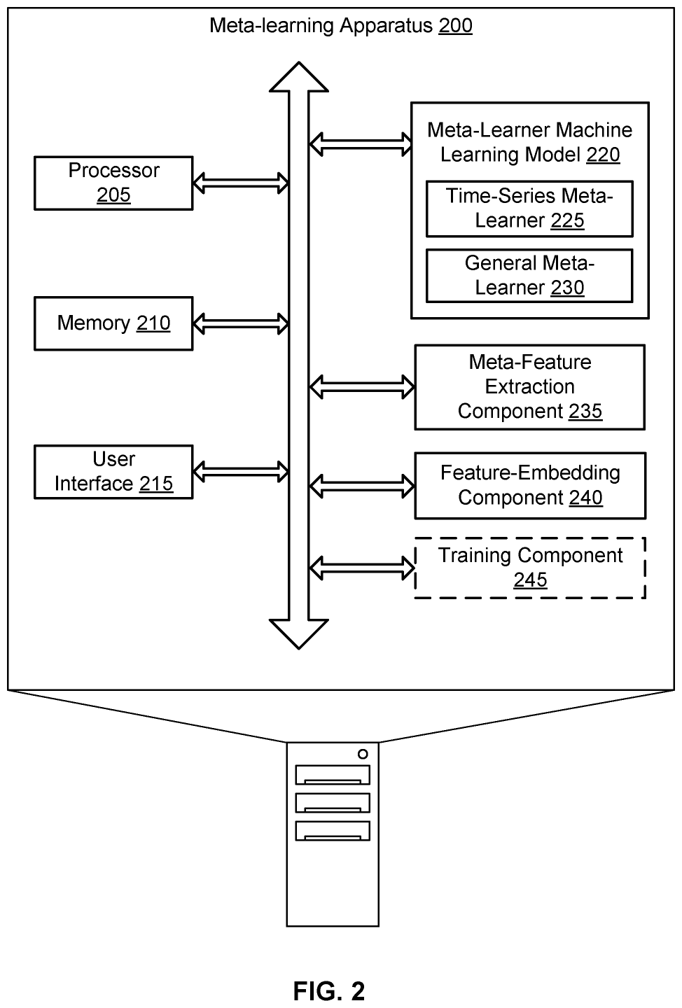

According to some aspects, meta-learning apparatus 100 receives a time-series dataset. In some examples, meta-learning apparatus 100 generates predicted time-series data based on the time-series dataset using the selected forecasting model. An example of meta-learning apparatus 100 will be described in greater detail with reference to FIG. 2.

Time-series data, forecasting models, code containing instructions for meta-learning apparatus 100, and other information used by meta-learning apparatus 100 may be stored on a database. A database is an organized collection of data. For example, a database stores data in a specified format known as a schema. A database may be structured as a single database, a distributed database, multiple distributed databases, or an emergency backup database. In some cases, a database controller may manage data storage and processing in database 110. In some cases, user 115 interacts with the database controller. In other cases, the database controller may operate automatically without user interaction.

Network 105 facilitates the transfer of information between user 115, database 110, and meta-learning apparatus 100. Network 105 may be referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of a meta-learning apparatus 200 according to aspects of the present disclosure. The example shown includes meta-learning apparatus 200, processor 205, memory 210, user interface 215, meta-learner machine learning model 220, meta-feature extraction component 235, feature-embedding component 240, and training component 245. Meta-learning apparatus 200 is an example of, or includes aspects of, the corresponding element described with reference to FIG. 1.

Processor 205 executes instructions which implement components of meta-learning apparatus 200. A processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. The memory array may be within a memory located on meta-learning apparatus 200, such as memory 210, or may be included in an external memory. In some embodiments, the memory controller is integrated into processor 205. Processor 205 is configured to execute computer-readable instructions stored in memory 210 to perform various functions. In some embodiments, processor 205 includes special purpose components for modem processing, baseband processing, digital signal processing, or transmission processing.

Memory 210 stores instructions executable by processor 205, and may further be used to store data such as performance and meta-feature tensors. Memory 210 may work with a database as described with reference to FIG. 1 to provide storage for meta-learning apparatus 200. Memory 210 includes one or more memory devices. Examples of a memory device include random access memory (RAM), read-only memory (ROM), or a hard disk. Further examples include solid state memory and a hard disk drive. In some examples, memory is used to store computer-readable, computer-executable software including instructions that, when executed, cause processor 205 to perform various functions described herein. In some cases, memory 210 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

User interface 215 allows a user to input or specify an input time-series dataset for processing. Meta-learning apparatus 200 may display the selected model or the forecasted data from the selected model to the user via user interface 215. A user interface may enable a user to interact with a device. In some embodiments, the user interface may include an audio device, such as an external speaker system, an external display device such as a display screen, or an input device (e.g., remote control device interfaced with user interface 215 directly or through an IO controller module). In some cases, a user interface may be a graphical user interface (GUI).

Meta-learner machine learning model 220 is used to determine a forecasting model with the highest expected performance for an input time-series dataset. In an example, meta-learner machine learning model 220 learns relationships between various measures of time-series data called “meta-features,” and the predicted performance of the time-series data with forecasting models in a model space.

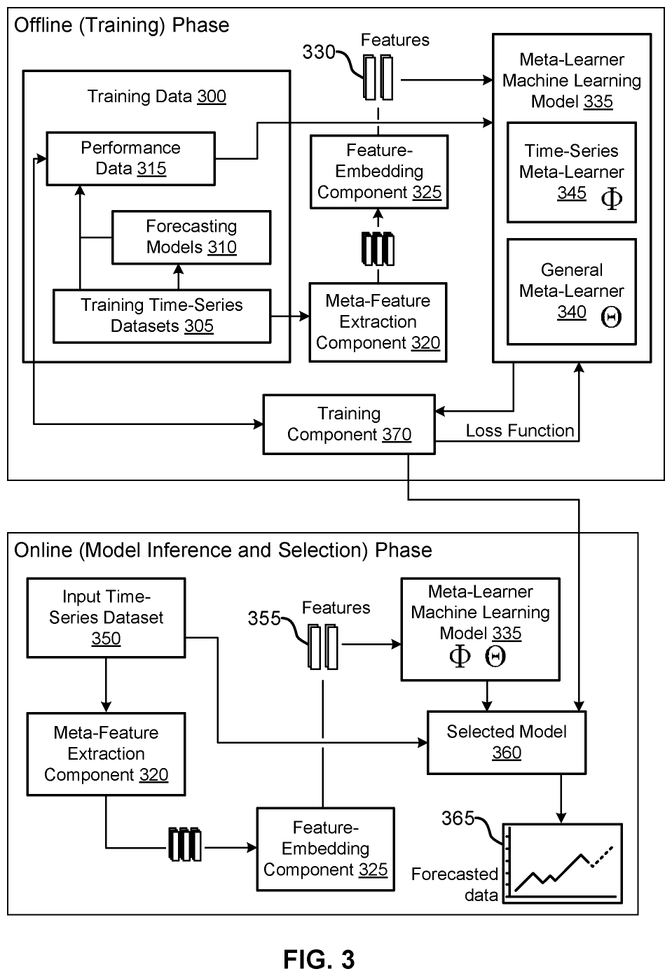

According to some aspects, meta-learner machine learning model 220 receives time-series meta-feature vector as input and generates a performance score for a forecasting model therefrom. In some examples, meta-learner machine learning model 220 selects the forecasting model from a set of forecasting models based on the performance score. In some examples, meta-learner machine learning model 220 identifies a set of hyperparameters for each of the set of forecasting models. In some examples, meta-learner machine learning model 220 selects a hyperparameter from the set of hyperparameters using the meta-learner machine learning model 220, where the predicted time-series data is based on the selected hyperparameter. Meta-learner machine learning model 220 is an example of, or includes aspects of, the corresponding element described with reference to FIG. 3.

Embodiments of meta-learner machine learning model 220 include one or more artificial neural networks (ANNs). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Time-series meta-learner 220 and general meta-learner 230 may each implement multivariate regression models. Multivariate regression is a technique used to measure the degree to which variables in a set of variables are related to each other. In some embodiments, time-series meta-learner 220 and general meta-learner 230 may each include a recurrent neural network (RNN) as part of their architecture, which is configured to process time-series data and extract salient information. An RNN is a class of ANN in which connections between nodes form a directed graph along an ordered (i.e., a temporal) sequence. This enables an RNN to model temporally dynamic behavior such as predicting what element should come next in a sequence. Thus, an RNN is suitable for tasks that involve ordered sequences such as text recognition (where words are ordered in a sentence). The term RNN may include finite impulse recurrent networks (characterized by nodes forming a directed acyclic graph), and infinite impulse recurrent networks (characterized by nodes forming a directed cyclic graph).

General meta-learner 230 learns relationships between the performances of forecasting models and meta-features extracted from various datasets. In some embodiments, general meta-learner 230 learns of these relationships in the context of each time window in the dataset, producing different weightings in different time windows. According to some aspects, general meta-learner 230 generates second predicted performance data for each of the set of forecasting models, where the forecasting model is selected based on the second predicted performance data. In some examples, general meta-learner 230 provides the second predicted performance data as an input to the time-series meta-learner 225. General meta-learner 230 is an example of, or includes aspects of, the corresponding element described with reference to FIG. 3. A detailed example of the general meta-learner 230 and the time-series meta-learner 225, along with the computations they perform, is provided with reference to FIG. 9 in the description of the training methods.

Time-series meta-learner 220 learns relationships between the performance of forecasting models and meta-features, and further attempts to learn relationships across time windows in a dataset. Accordingly, embodiments of time-series meta-learner 220 incorporate the results of previous time-windows as inputs (e.g., into layers of the RNN) for future time windows. Accordingly, embodiments of time-series meta-learner 220 incorporate a long short-term memory (LSTM) structure. An LSTM is a form of RNN that includes feedback connections. In one example, and LSTM includes a cell, an input gate, an output gate and a forget gate. The cell stores values for a certain amount of time., The gates dictate the flow of information into and out of the cell. LSTM networks may be used for making predictions based on series data where there can be gaps of unknown size between related information in the series. LSTMs can help mitigate the vanishing gradient (and exploding gradient) problems when training an RNN. Additional detail regarding the structure of time-series meta-learner 220 will be provided with reference to FIG. 3.

According to some aspects, time-series meta-learner 225 divides the time-series dataset into a set of time windows. In some examples, time-series meta-learner 225 identifies a time window of the set of time windows, where the forecasting model is selected based on the identified time window. For example, time-series meta-learner 225 may select a forecasting model for one time window of a given dataset, and select another forecasting model for a different time window of the same dataset. In some examples, time-series meta-learner 225 generates first predicted performance data for each of the set of forecasting models, where the forecasting model is selected based on the first predicted performance data. Time-series meta-learner 225 is an example of, or includes aspects of, the corresponding element described with reference to FIG. 3.

Meta-feature extraction component is configured to compute a variety of measures, referred to as meta-features, from a time-series dataset. Some of the measures include statistics, results from transform operations, and various other meta information from the data.

According to some aspects, meta-feature extraction component 235 is configured to compute a plurality of meta-features based on a time-series dataset. According to some aspects, meta-feature extraction component 235 computes a time-series meta-feature vector based on the time-series dataset, which includes the plurality of meta-features. In some aspects, the set of meta-features include an aggregate statistic of the time-series dataset.

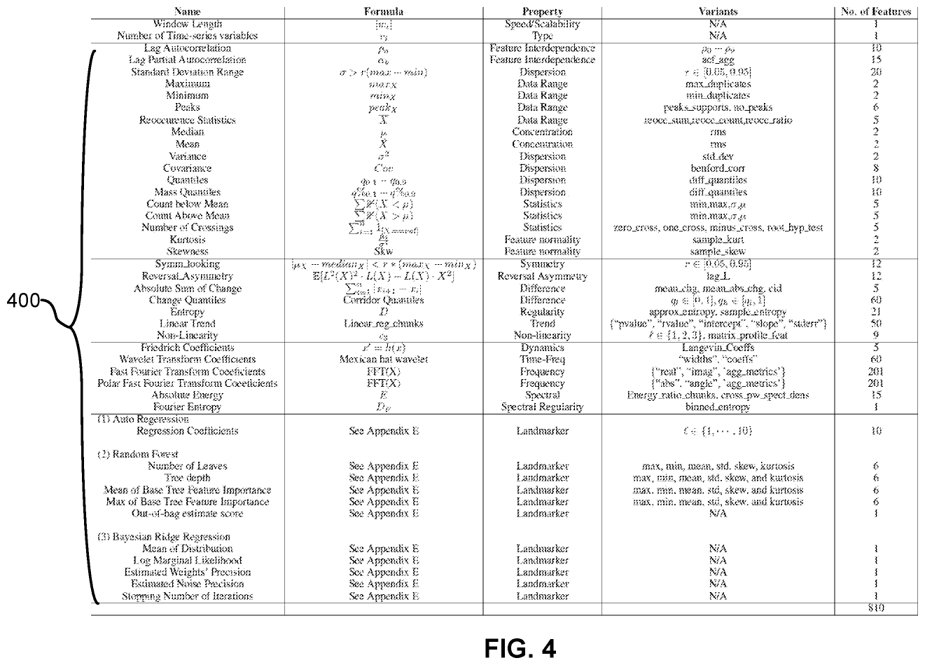

Meta-feature extraction component 235 is an example of, or includes aspects of, the corresponding element described with reference to FIG. 3. Examples of meta-features will be described later with reference to FIG. 4.

Feature-embedding component 240 is configured to reduce a dimensionality of the plurality of meta-features. According to some aspects, feature-embedding component 240 performs a principal component analysis on the set of meta-features to obtain the time-series meta-feature vector. Principal component analysis (PCA) involves identifying the principal components from data such as an n-dimensional vector. The principal components may be represented as a sequence of unit vectors, where the i-th vector is the direction of a line that best fits the data while being orthogonal to the first i−1 unit vectors. In some cases, PCA projects each data point onto only the first few principal components to obtain lower-dimensional data while preserving the original data's variation. Feature-embedding component 240 is an example of, or includes aspects of, the corresponding element described with reference to FIG. 3.

According to some aspects, training component 245 is configured to update parameters of the meta-learner machine learning model 220 based on a loss function. Training component 245 is used to train meta-learner machine learning model 220 based on known performance data of forecasting models and predicted performance data from meta-learner machine learning model 220. For example, training component 245 may calculate a Mean Squared Error (MSE) and Mean Absolute Percentage Error (MAPE) between the known performances and the predicted performances from meta-learner machine learning model 220, where the loss function is based on the MSE or the MAPE. In some embodiments, training component 245 is further configured to train a selected forecasting model, so that the model can be used to forecast data based on an input dataset. For example, according to some aspects, training component 245 receives a time-series training set to be applied to the selected forecasting model. In some examples, training component 245 trains the selected forecasting model based on the time-series training set, where the predicted time-series data is generated from meta-learning apparatus 200 based on the training.

According to some aspects, training component 245 identifies a training set including a set of time-series datasets, a set of forecasting models, and ground-truth performance data for the set of forecasting models applied to each of the set of time-series datasets. In some examples, training component 245 compares the predicted performance data to the ground-truth performance data. In some examples, training component 245 updates parameters of the meta-learner machine learning model 220 based on the comparison. In some examples, training component 245 computes a loss function based on the predicted performance data and the ground-truth performance data, where the parameters of the meta-learner machine learning model 220 are based on the loss function.

In some examples, training component 245 computes a time-series loss term based on an output of a time-series meta-learner 225. In some examples, training component 245 computes a general loss term based on an output of a general meta-learner 230, where the loss function includes the time-series loss term and the general loss term. In some examples, training component 245 applies each of the set of forecasting models to each of the set of time-series datasets to obtain the ground-truth performance data. In some examples, training component 245 trains a forecasting model of the set of forecasting models on each of the set of time-series datasets to obtain a trained forecasting model, where the ground-truth performance data is based on the trained forecasting model. Training component 245 is an example of, or includes aspects of, the corresponding element described with reference to FIG. 3.

As previously described, some embodiments of a meta-learner machine learning model include two types of meta-learning models, a time-series meta-learner and a general meta-learner. This is because time-series datasets can be dissimilar from one another with respect to time dependency. Historical data for forecasting models indicates that some datasets have strong temporal dependency; i.e., there are strong relationships across local and far time-windows of the dataset. Other datasets have been observed to have relatively weak temporal dependence. In such cases, values are better predicted using a combination of temporal relationships and data characteristics. These characteristics can be measured and extracted in the form of meta-features, which will be discussed in further detail later.

Time-series datasets may have varying temporal dependency, for example, softer or stronger relationships across different windows of time. Accordingly, embodiments of the meta-learning apparatus implement two techniques for meta-learning which allows them to generalize to new unseen datasets. Firstly, embodiments learn similarity across datasets by extracting meta-features that capture characteristics of the datasets. These meta-features are applied to the general meta-learner of the meta-learner machine learning model, which learns to predict the performance of a model for a time window within a dataset using the meta-features. Secondly, embodiments learn a model's performance evolution over successive time windows for the same dataset via the time-series meta-learner of the meta-learner machine learning model. In some embodiments, predicted performance data from the general meta-learner is applied to the time-series meta-learner, which then infers a forecasting model for a new dataset based on the performance data from the general meta-learner and on extracted meta-features from the dataset. A detailed example of the general meta-learner and the time-series meta-learner, along with the computations they perform, is provided with reference to FIG. 9 in the description of the training methods.

During an offline training portion, some embodiments use performance data which measures the performance of a plurality of forecasting models as applied to a plurality of datasets. The meta-learner machine learning model may be trained on the performance data and extracted meta-features from the plurality of datasets, learning relationships between the two. In other words, the meta-learner machine learning model may understand which characteristics of time-series data are most suitable to certain types of forecasting models.

At model selection (i.e., inference) time, the meta-learning apparatus receives a new dataset. Then, a meta-feature extraction component extracts meta-features from the dataset. In some embodiments, a feature embedding component performs principal component analysis (PCA) on the meta-features to encode the most salient features before the meta-features are applied to the trained meta-learner machine learning model. The meta-learner machine learning model then uses the meta-features to select a forecasting model with the highest predicted performance from a plurality of forecasting models. Finally, the meta-learner machine learning model provides the selected model as an output. FIG. 3 illustrates one embodiment of this process.

FIG. 3 shows an example of a pipeline for automatically selecting a forecast model according to aspects of the present disclosure. The example shown includes training data 300, meta-feature extraction component 320, feature-embedding component 325, training time-series datasets meta-features 330, meta-learner machine learning model 335, input time-series dataset 350, input time-series dataset meta-features 355, selected model 360, predicted time-series data 365, and training component 370. Meta-feature extraction component 320, feature-embedding component 325, meta-learner machine learning model 335, general meta-learner 340, time-series meta-learner 345, and training component 370 are examples of, or include aspects of, the corresponding elements described with reference to FIG. 2.

Some embodiments of a meta-learning system include an offline training phase before using meta-learner machine learning model 335 to automatically select forecasting models. In this example, a meta-learning apparatus receives training data 300. Training data 300 includes training time-series datasets 305, forecasting models 310, and performance data 315. Some examples of time-series datasets 305 include univariate datasets with single time-series variables, and multivariate datasets with multiple time-series variables. Forecasting models 310 may include several available forecasting models, and may implement algorithms such as DeepAR, DeepFactor, Prophet, Seasonal Naïve, etc., and are not limited thereto. Performance data 315 includes the performances of the forecasting models as applied to the time-series datasets. Performance data 315 may be formed as a tensor including this information. Additional detail regarding performance tensors will be discussed later.

Meta-feature extraction component 320 extracts meta-features from training time-series datasets 305. Examples of meta-features will be discussed in more detail with reference to FIG. 4. In some cases, feature-embedding component 325 then performs PCA on the features to yield training time-series datasets meta-features 330.

Performance data 315 and training time-series datasets meta-features 330 are then input into meta-learner machine learning model 335. In one aspect, meta-learner machine learning model 335 includes general meta-learner 340 and time-series meta-learner 345. During the offline training phase, meta-learner machine learning model 335 learns relationships between forecasting models and time-series meta-features using performance data 315 and training time-series datasets meta-features 330. For example, training component 370 generates a loss function based on performance data 315 and predicted performance data. Then, parameters of meta-learner machine model 335 are updated based on the applied loss function.

After the offline training phase, meta-learner machine learning model 335 is configured to automatically select a forecasting model for an unseen dataset. During an online inference phases, the meta-learning apparatus receives input time-series dataset 350. Then, meta-feature extraction component 320 extracts all meta-features, and optionally feature-embedding component 325 performs PCA to retain salient meta-features from the input, i.e. input time-series dataset meta-features 355. Input time-series dataset meta-features 355 are then applied to meta-learner machine learning model 335. Meta-learning machine learning model 335 selects a forecasting model with the highest predicted performance to output as selected model 360.

In some cases, time-series meta-learner 345 predicts one forecasting model and general meta-learner 340 predicts a different forecasting model. While varying according to embodiments, some embodiments choose the model with the highest predicted performance as selected model 360.

In some cases, training component 370 may further be used to train selected model 360. Once selected model 360 is trained, it may be used to forecast data based on input time-series dataset 350. In this way, the meta-learning system as described herein may be used to automatically select a high performing forecasting model for an arbitrary dataset, without the need to train and test several different datasets beforehand. Accordingly, the meta-learning system can significantly reduce the time used to find a model and generate forecasted data.

FIG. 4 shows an example of meta-features 400 from time-series data according to aspects of the present disclosure. Several meta-features correspond to aggregate statistics, such as mean, variance, skewness, number of time-series variables, etc. Other meta-features are computed after various transforms are performed on the data. For example, wavelet transforms and Fourier transforms may be performed on the data to extract coefficients. The Auto Regression, Random Forest, and Bayesian Ridge Regression meta-features may be computed from various available algorithms for time-series data.

The various extracted meta-features are provided to the meta-learner machine learning model during an offline training phase. The training allows the model to learn how these features and their values affect the performance of different forecasting models as applied to the datasets from which the features are extracted. The offline training phase will be described in greater detail with reference to FIG. 9.

Meta-features are also extracted from an input time-series dataset during online inference time. They are used by the trained meta-learner machine learning model to choose the forecasting model with the highest predicted performance for the input time-series dataset.

### Model Selection and Data Forecasting

A method for automatic model selection using meta-learning is described. One or more aspects of the method include receiving a time-series dataset; computing a time-series meta-feature vector based on the time-series dataset; generating a performance score for a forecasting model using a meta-learner machine learning model that takes the time-series meta-feature vector as input; selecting the forecasting model from a plurality of forecasting models based on the performance score; and generating predicted time-series data based on the time-series dataset using the selected forecasting model.

Some examples of the method, apparatus, non-transitory computer readable medium, and system further include dividing the time-series dataset into a plurality of time windows. Some examples further include identifying a time window of the plurality of time windows, wherein the forecasting model is selected based on the identified time window.

Some examples of the method, apparatus, non-transitory computer readable medium, and system further include computing a plurality of meta-features based on the time-series dataset. Some examples further include generating the time-series meta-feature vector based on the plurality of meta-features. In some aspects, the plurality of meta-features include an aggregate statistic of the time-series dataset. Some examples of the method, apparatus, non-transitory computer readable medium, and system further include performing a principal component analysis on the plurality of meta-features to obtain the time-series meta-feature vector.

Some examples of the method, apparatus, non-transitory computer readable medium, and system further include generating first predicted performance data for each of the plurality of forecasting models using a time-series meta-learner of the meta-learner machine learning model, wherein the forecasting model is selected based on the first predicted performance data. Some examples further include generating second predicted performance data for each of the plurality of forecasting models using a general meta-learner of the meta-learner machine learning model, wherein the forecasting model is selected based on the second predicted performance data. Some examples further include providing the second predicted performance data as an input to the time-series meta-learner.

Some examples of the method, apparatus, non-transitory computer readable medium, and system further include identifying a plurality of hyperparameters for each of the plurality of forecasting models. Some examples further include selecting a hyperparameter from the plurality of hyperparameters using the meta-learner machine learning model, wherein the predicted time-series data is based on the selected hyperparameter.

Some examples of the method, apparatus, non-transitory computer readable medium, and system further include receiving a time-series training set. Some examples further include training the selected forecasting model based on the time-series training set, wherein the predicted time-series data is generated based on the training.

FIG. 5 shows an example of a method 500 for providing a forecasting model with the highest predicted performance according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, a user provides a time-series dataset. The user may upload, select, or otherwise identify an input time-series dataset for processing via, for example, a user interface such as a web application.

At operation 510, the system extracts meta-features from the time-series dataset. Extracting the meta-features may include calculation operations, such as computing aggregate statistics of the time-series dataset, transforming the data to determine regression coefficients, and other operations. Examples of meta-features are given with reference to FIG. 4.

At operation 515, the system generates performance scores for multiple forecasting models based on meta features. The performance scores may be predictions of performances for different available forecasting models. In some cases, a time-series meta-learner of the system generates a first set of performances score corresponding to each model, and a general meta-learner of the system generates a second set of performance scores corresponding to each model. In some examples, output from the general meta-learner is applied to the time-series meta-learner, or vice-versa.

At operation 520, the system selects forecasting model with highest predicted performance. At operation 525, the system provides selected forecasting model. For example, the system may provide the selected forecasting model to another component or apparatus configured to process the time-series dataset with the selected forecasting model to generate forecasted data.

As described with reference to FIG. 3, a meta-learner machine learning model according to embodiments is configured to receive a time-series dataset and infer a forecasting model with the highest predicted performance for that dataset. An example algorithmic process will now be described.

Given a new time-series dataset Dₜₑₛₜ, a meta-feature extraction component computes a meta features tensor \hat{F}ₜₑₛₜ=ψ(Dₜₑₛₜ), which contains aggregate statistics and other measurements of Dₜₑₛₜ such as those provided in FIG. 4. In some embodiments, a feature embedding component uses PCA to embed \hat{F}ₜₑₛₜ in a reduced-dimension space to obtain the final meta-features tensor Fₜₑₛₜ. Then, at inference time, the meta-learner machine learning model predicts performances for each available performance model in model space [symbol] . The model [symbol] ₜ with the lowest predicted error score [symbol] (which means, in some cases, the highest predicted performance) on the time window wₜ is then chosen as the selected model for that time window wₜ. This process is then repeated for all time windows w₀, w₁, . . . , wₜ of Dₜₑₛₜ.

For example, for a first time window (w₀), the inference is computed by:

[symbol]

ₜ∈arg [symbol] (F₀^{test}) (1)

For subsequent time windows, an inference recommendation from a time-series meta-learner Θ of the meta-learner machine learning model depends on the history of the model's performances over previous time windows:

[symbol]

ₜ^{Θ}∈arg [symbol] Θ(F₀^{test}, . . . , Fₜ₋₁^{test}, Fₜ^{test}, \hat{p}₀^{test}, . . . , \hat{p}ₜ₋₁^{test}) (2)

A general meta-learner Φ of the meta-learner machine learning model, on the other hand, depends on a predicted (regression) output of meta-features from the current time window as applied to it:

[symbol]

ₜ^{Φ}∈arg [symbol] Φ(Fₜ^{test}) (3)

Thus, in embodiments of the meta-learner machine learning model that include both the time-series meta-learner Θ and the general meta-learner Φ, the final inferred model is given by:

$${t}_{} ∈ {arg min}_{\overline{M} ∈ \{ {\hat{ℳ}}_{t}^{Φ} , {\hat{ℳ}}_{t}^{Θ} \}} {\hat{p}}_{t}^{test} ( \overline{M} ) \qquad ( 4 )$$

In some cases, two or more forecasting models may tie in the predicted performances. The methods in selecting a forecasting model in the event of a tie in the predicted performances may vary according to different embodiments. For example, some embodiments may weigh the influence of meta-features extracted from the dataset differently.

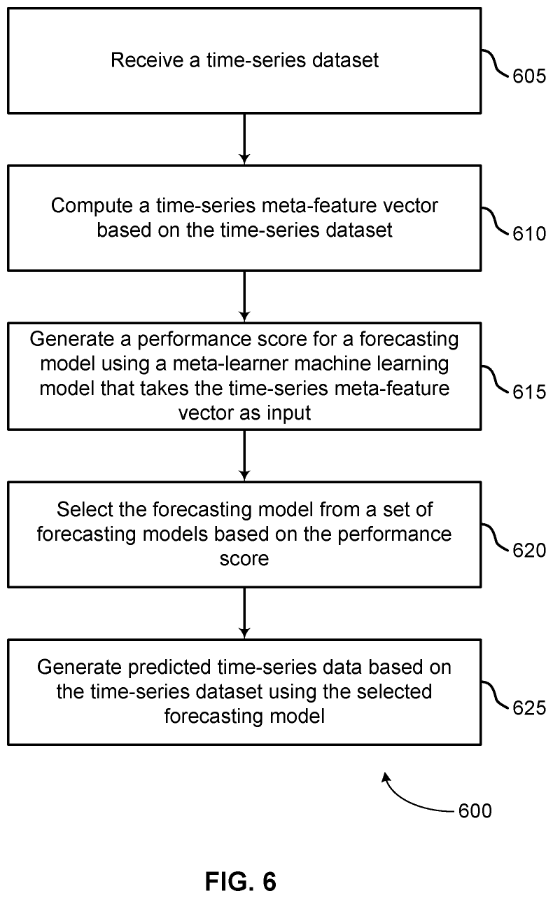

FIG. 6 shows an example of a method 600 for predicting time-series data according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system receives a time-series dataset. In some cases, the operations of this step refer to, or may be performed by, a meta-learning apparatus as described with reference to FIGS. 1 and 2. The time-series dataset may be univariate or multivariate. In the case of a multivariate dataset, the system will choose a model that is capable of predicting values for multiple independent variables.

At operation 610, the system computes a time-series meta-feature vector based on the time-series dataset. In some cases, the operations of this step refer to, or may be performed by, a meta-feature extraction component as described with reference to FIGS. 2 and 3. The time-series meta-feature vector may be consolidated or reduced in dimensionality. For example, a feature-embedding component may perform PCA on the meta-feature vector to generate a final meta-feature vector.

At operation 615, the system generates a performance score for a forecasting model using a meta-learner machine learning model that takes the time-series meta-feature vector as input. In some cases, the operations of this step refer to, or may be performed by, a meta-learner machine learning model as described with reference to FIGS. 2 and 3. As described above, some embodiments of the meta-learner machine learning model include both a time-series meta-learner and a general meta-learner. In such embodiments, operation 615 may be performed by the time-series meta-learner.

At operation 620, the system selects the forecasting model from a set of forecasting models based on the performance score. In some cases, the operations of this step refer to, or may be performed by, a meta-learner machine learning model as described with reference to FIGS. 2 and 3.

At operation 625, the system generates predicted time-series data based on the time-series dataset using the selected forecasting model. In some cases, the operations of this step refer to, or may be performed by, a meta-learning apparatus as described with reference to FIGS. 1 and 2. In some cases, the system will train the selected forecasting model before generating the predicted time-series data.

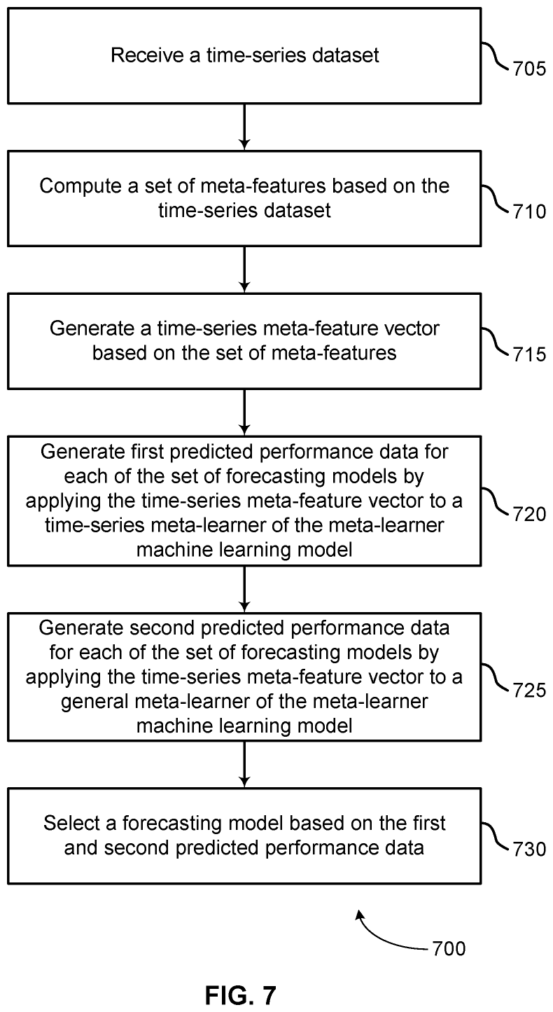

FIG. 7 shows an example of a method 700 for selecting a forecasting model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system receives a time-series dataset. In some cases, the operations of this step refer to, or may be performed by, a meta-learning apparatus as described with reference to FIGS. 1 and 2. At operation 710, the system computes a set of meta-features based on the time-series dataset. In some cases, the operations of this step refer to, or may be performed by, a meta-feature extraction component as described with reference to FIGS. 2 and 3. At operation 715, the system generates a time-series meta-feature vector based on the set of meta-features. In some cases, the operations of this step refer to, or may be performed by, a meta-learner machine learning model as described with reference to FIGS. 2 and 3.

At operation 720, the system generates first predicted performance data for each of the set of forecasting models by applying the time-series meta-feature vector to a time-series meta-learner of the meta-learner machine learning model. In some cases, the operations of this step refer to, or may be performed by, a meta-learner machine learning model as described with reference to FIGS. 2 and 3. The first predicted performance data may be generated by a model that considers relationships across various time windows, such as an LSTM component of the time-series meta-learner. In some cases, the first predicted performance data describes a performance for one time window of the time-series dataset.

At operation 725, the system generates second predicted performance data for each of the set of forecasting models by applying the time-series meta-feature vector to a general meta-learner of the meta-learner machine learning model. In some cases, the operations of this step refer to, or may be performed by, a meta-learning apparatus as described with reference to FIGS. 1 and 2. The general meta-learner may consider the relationships between the meta-features and the currently selected model for only one time window, rather than across time windows. In some cases, the second predicted performance data describes performance for one time window of the time-series dataset.

At operation 730, the system selects a forecasting model based on the first and second predicted performance data. In some cases, a single forecasting model is selected and output. In some cases, the system selects multiple forecasting models for corresponding different time windows of the time-series dataset, and outputs the multiple forecasting models along with information on how to use them for different portions of the dataset.

Forecasting algorithms frequently contain a set of hyperparameters that alter the model in some way. For example, the DeepAR forecasting algorithm uses an RNN, and one of the hyperparameters changes the number of layers in its RNN. Though the overall algorithm remains the same, changing the number of layers effectively changes the model used. Embodiments of the meta-learning apparatus described herein use a model space including several models, each with associated hyperparameters.

The following table describes an example model space with associated hyperparameters. The totals column represents how many unique forecasting models based on each algorithm that can be used by adjusting the hyperparameters.

TABLE 1
Example time-series forecasting model space.

| Forecasting | | | Data | |
|---|---|---|---|---|
| Algorithm | HyperParameter 1 | HyperParameter 2 | Representation | Total |
| DeepAR | num_cells = [10, 20, 30, 40, 50] | num_rnn_layers = | {Exp_smoothing, | 50 |
| | | [1, 2, 3, 4, 5] | Raw} | |
| DeepFactor | num_hidden_global = | num_global_factors = | {Exp_smoothing, | 50 |
| | [10, 20, 30, 40, 50] | [1, 5, 10, 15, 20] | Raw} | |
| Prophet | changepoint_prior_scale = | seasonality_prior_scale = | {Exp_smoothing, | 50 |
| | [0.001, 0.01, 0.1, 0.2, 0.5] | [0.01, 0.1, 1.0, 5.0, | Raw} | |
| | | 10.0] | | |
| Seasonal | season_length = [1, 5, 7, 10, 30] | N/A | {Exp_smoothing, | 10 |
| Naïve | | | Raw} | |
| Gaussian | cardinality = [2, 4, 6, 8, 10] | max_iter_jitter = | {Exp_smoothing, | 50 |
| Process | | [5, 10, 15, 20, 25] | Raw} | |
| Vector Auto | cov_type = | trend = {‘n’, ‘c’, ‘t’, | {Exp_smoothing, | 40 |
| Regression | {“HC0”, “HC1”, “HC2”, “HC3”, | ‘ct’} | Raw} | |
| | “nonrobust”} | | | |
| Random | n_estimators = | max_depth = | {Exp_smoothing, | 72 |
| Forest | [10, 50, 100, 250, 500, 1000] | [2, 5, 10, 25, 50, ‘None’] | Raw} | |
| Regressor | | | | |
| | | | | 322 |

Accordingly, some embodiments train the meta-learner machine learning model with performance data from 322 unique forecasting models, where the performance data includes performances of each of the forecasting models run on a plurality of datasets. Embodiments are not limited thereto, however, and embodiments may be trained on a different model space with consideration that new forecasting models are constantly being developed.

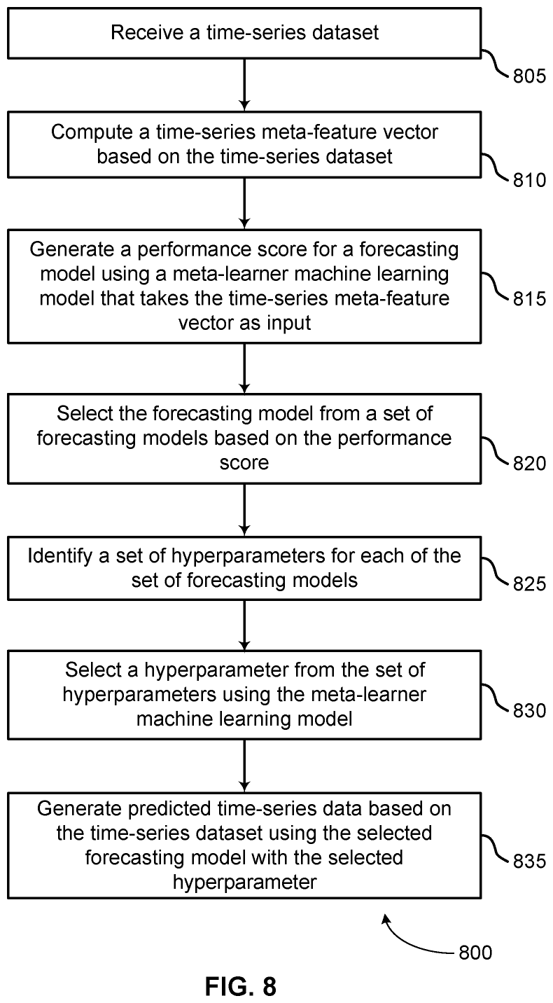

FIG. 8 shows an example of a method 800 for generating predicted time-series data according to a forecasting model with hyperparameters according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system receives a time-series dataset. In some cases, the operations of this step refer to, or may be performed by, a meta-learning apparatus as described with reference to FIGS. 1 and 2. At operation 810, the system computes a time-series meta-feature vector based on the time-series dataset. In some cases, the operations of this step refer to, or may be performed by, a meta-feature extraction component as described with reference to FIGS. 2 and 3.

At operation 815, the system generates a performance score for a forecasting model using a meta-learner machine learning model that takes the time-series meta-feature vector as input. In some cases, the operations of this step refer to, or may be performed by, a meta-learner machine learning model as described with reference to FIGS. 2 and 3. At operation 820, the system selects the forecasting model from a set of forecasting models based on the performance score. In some cases, the operations of this step refer to, or may be performed by, a meta-learner machine learning model as described with reference to FIGS. 2 and 3.

At operation 825, the system identifies a set of hyperparameters for each of the set of forecasting models. In some cases, the operations of this step refer to, or may be performed by, a meta-learning apparatus as described with reference to FIGS. 1 and 2. At operation 830, the system selects a hyperparameter from the set of hyperparameters using the meta-learner machine learning model. In some cases, the operations of this step refer to, or may be performed by, a meta-learner machine learning model as described with reference to FIGS. 2 and 3. The selection of the hyperparameter may be made by the trained meta-learner machine learning model, which considers the characteristics (e.g., meta-features) of the time-series dataset in its selection.

At operation 835, the system generates predicted time-series data based on the time-series dataset using the selected forecasting model with the selected hyperparameter. In some cases, the operations of this step refer to, or may be performed by, a meta-learner machine learning model as described with reference to FIGS. 2 and 3.

### Training Methods

A method for automatic model selection using meta-learning is described. The method includes training a meta-learner machine learning model. One or more aspects of the method include identifying a training set comprising a plurality of time-series datasets, a plurality of forecasting models, and ground-truth performance data for the plurality of forecasting models applied to each of the plurality of time-series datasets; generating predicted performance data for the plurality of forecasting models applied to each of the plurality of time-series datasets using the meta-learner machine learning model; comparing the predicted performance data to the ground-truth performance data; and updating parameters of the meta-learner machine learning model based on the comparison.

Some examples of the method, apparatus, non-transitory computer readable medium, and system further include computing a loss function based on the predicted performance data and the ground-truth performance data, wherein the parameters of the meta-learner machine learning model are based on the loss function. Some examples further include computing a time-series loss term based on an output of a time-series meta-learner. Some examples further include computing a general loss term based on an output of a general meta-learner, wherein the loss function comprises the time-series loss term and the general loss term.

Some examples of the method, apparatus, non-transitory computer readable medium, and system further include applying each of the plurality of forecasting models to each of the plurality of time-series datasets to obtain the ground-truth performance data. Some examples of the method, apparatus, non-transitory computer readable medium, and system further include training a forecasting model of the plurality of forecasting models on each of the plurality of time-series datasets to obtain a trained forecasting model, wherein the ground-truth performance data is based on the trained forecasting model.

The learning process for the meta-learner machine learning model includes loss functions based on multi-output regression. Several different loss metrics can be used, including Mean Squared Error (MSE) and Mean Absolute Percentage Error (MAPE). Some embodiments of the meta-learner machine learning model include the general meta-learner and the time-series meta-learner described above.

An embodiment of the general meta-learner Φ uses a multivariate regression model to predict the highest performing model for each task, or the highest performing model for a time window of each task, without accounting for a temporal relationship between different time windows. In an embodiment, a training component runs all models in a set of forecasting models [symbol] on different time windows wₜ with t∈{1, . . . , T} for all datasets in a training database [symbol] ₜᵣₐᵢₙ. Running the models produces a set of N=T×n distinct training samples in a meta-features matrix and a performance vector (Fₜⁱ, pₜⁱ), where F denotes the meta-features and p the performances, and with t∈[1, T] and i∈[1, n]. Accordingly, the multi-output regression model can be described with the following equation:

\hat{p}ₜⁱ=Φ(Fₜⁱ, β);t∈[1,T], i∈[1, n] (5)

where Φ denotes the regression function and β are the unknown regression parameters. The general meta-learner's objective is denoted by loss function L_{Φ}:

$${L}_{Φ} = {\sum }_{t = 1}^{T} {\sum }_{n = 1}^{n} L ( {\hat{p}}_{t}^{i} , {p}_{t}^{i} ) \qquad ( 6 )$$

where L is the loss metric, such as MSE, MAPE, etc., which measures the difference between the predicted performance based on the meta-features/regression parameters and a ground-truth performance. In this way, the general meta-learner Φ learns a mapping between the meta-features of a time window in a dataset and a corresponding highest performing model in the model space.

An embodiment of the time-series meta-learner Θ uses a long short-term memory artificial neural network (LSTM) in a time-series multi-regression model. The LSTM-based time-series meta-learner Θ learns how different forecasting models' performances evolve with meta-feature matrices over time.

Performance data for the models may be represented in a performance tensor P. Given a training dataset Dₜᵣₐᵢₙ and a model space [symbol] , performance tensor P∈ [symbol] ^{T×n×m} may be defined as

P={P₁, P₂, . . . , P_{T}} (7)

where Pₖ=(pₖ^{i,j})∈ [symbol] ^{n×m} and the element pₖ^{i,j}=Mⱼ(wₖ(Dᵢ)) denotes the j^{th} model Mⱼ's performance on the time window wₖ of the i^{th} training dataset Dᵢ. In some embodiments, the performance of a forecasting model for a time window is determined by the forecasting error (calculated by, e.g., MSE) of that model in the time windw.

Meta-features may be represented in a meta-features tensor Fᵢ={F₁ⁱ, . . . , F_{T}ⁱ} [symbol] ^{T×d×} [symbol] ^{ᵢ} for a time-series dataset Dᵢ, where T is the number of time windows, d is the number of meta-features, and [symbol] is the number of variables in Dᵢ.

For a dataset Dᵢ, the meta-feature extraction component time-series meta-feature matrices F₁ⁱ, F₂ⁱ, . . . Fₜⁱ, and the training component provides the ground-truth performance data of the dataset as a history of performance vectors p₁ⁱ, . . . pₜ₋₁ⁱ. The objective of the time-series meta-learner Θ is to predict performance vector pₜⁱ at current time window wₜ. The time-series regression model can therefore be described by:

\hat{p}ₜⁱ=Θ(F₁ⁱ, . . . , Fₜ₋₁ⁱ, Fₜⁱ,p₁ⁱ, . . . , pₜ₋₁ⁱ); i∈[1,n], t∈[1, T] (8)

where Θ denotes the time-series regression function.

Some embodiments of the time-series meta-learner Θ are configured to receive LSTM inputs. An LSTM input includes information from previous inputs over time. For example, if Xₜ represents an input at a time window wₜ, then Xₜ=[F₁ⁱ, p₁ⁱ, F₂ⁱ, p₂ⁱ, . . . , Fₜ₋₁ⁱ, pₜ₋₁ⁱ, Fₜⁱ]. Then, the output of the LSTM of the time-series meta-learner Θ is the predicted performance \hat{p}ₜⁱ, which is a function of Xₜ. In an example, a cell of the LSTM at time t includes two recurrent features, denoted by hₜⁱ and cₜⁱ, referring to a hidden state and a cell state, respectively. The cell includes three layers: a forget gate layer, an input gate layer, and an output gate layer. Activations of these respective layers may be described by the following:

fₜⁱ=σ(W_{f}·[hₜ₋₁ⁱ, Xₜ]+b_{f}),

lₜⁱ=σ(Wₗ·[hₜ₋₁ⁱ, Xₜ]+bₗ),

oₜⁱ=σ(Wₒ·[hₜ₋₁ⁱ, Xₜ]+bₒ) (9)

where W_{f}, Wₗ, Wₒ and b_{f}, bₗ, bₒ∈ [symbol] ^{m} denote the weights matrices and the biases of the three layers, respectively. These parameters are learned during the training of the time-series meta-learner, and are updated based on training data which includes training datasets, meta-features corresponding to the training datasets, and performance tensors of forecasting models as applied to the training datasets as described above.

In an example LSTM cell, a cell update uₜⁱ is implemented with a tanh activation function, such as the following:

uₜⁱ=tanh (Wᵤ·[hₜ₋₁ⁱ, Xₜ]+bᵤ) (10)

where Wᵤ and bᵤ∈ [symbol] ^{m} are an additional weight and bias to be learned during training. Therefore, in this example, new cell and hidden states at time t are given by:

cₜⁱ=fₜⁱ·cₜ₋₁ⁱ+lₜⁱ·uₜⁱ

\hat{h}ₜⁱ=oₜⁱ·tanh(cₜⁱ) (11)

And the output equations of the LSTM cell are given by:

Vₜⁱ=W [symbol] ĥₜⁱ+b

[symbol]

\hat{p}ₜⁱ=σ(Vₜⁱ) (12)

where [symbol] and [symbol] ∈ [symbol] ^{m} are learned weight and bias parameters. These equations (Eq.'s 8-12) describe an example relationship between the LSTM input Xₜ and the predicted performance output vector \hat{p}ₜⁱ.

In this example, the time-series meta-learner Θ learns the parameters W_{f}, b_{f}, Wₗ, bₗ, Wₒ, bₒ, Wᵤ, bᵤ, [symbol] during training, which are the weights and biases of the forget, input, and output layers, and cell updates, respectively. An embodiment of the time-series meta-learner Θ can update these parameters by minimizing a loss function described by:

$${L}_{Θ} = {\sum }_{t = 1}^{T} {\sum }_{n = 1}^{n} L ( {\hat{p}}_{t}^{i} , {p}_{t}^{i} ) \qquad ( 13 )$$

While this loss equation is a function of predicted performances similar to the loss equation for the general meta-learner, it should be noted that the loss incorporates the predicted performance based on both the history of the meta-features and the performance vectors across time windows, as shown with Equations 8-13.

Accordingly, a meta-learner machine learning model which includes both the general meta-learner Φ and the time-series meta-learner Θ may learn to optimize an objective given by a linear combination of the two, e.g.:

$${min}_{β , {W}_{f} , {b}_{f} , {W}_{l} , {b}_{l} , {W}_{o} , {b}_{o} , {W}_{u} , {b}_{u} , {W}_{v} , {b}_{v}} a {L}_{Φ} ( F , P ) + ( 1 - a ) {L}_{Θ} ( F , P ) \qquad ( 14 )$$

where a is a relative weight of the two-meta learners. This allows the meta-learning machine model to optimize the objective (i.e., minimize both loss components) over all datasets and all time windows. An example of this training process is described by FIG. 9.

FIG. 9 shows an example of a method 900 for training a meta-learner machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system identifies a training set including a set of time-series datasets, a set of forecasting models, and ground-truth performance data for the set of forecasting models applied to each of the set of time-series datasets. In some cases, the operations of this step refer to, or may be performed by, a training component as described with reference to FIGS. 2 and 3. The ground-truth performance data may be provided in the form of a performance tensor, as described above.

At operation 910, the system generates predicted performance data for the set of forecasting models applied to each of the set of time-series datasets using a meta-learner machine learning model. The predicted performance data is a measure of how accurate the system believes each forecasting model will be for each of the time-series datasets.

At operation 915, the system compares the predicted performance data to the ground-truth performance data. In some cases, the operations of this step refer to, or may be performed by, a training component as described with reference to FIGS. 2 and 3. At operation 920, the system updates parameters of the meta-learner machine learning model based on the comparison. In some cases, the operations of this step refer to, or may be performed by, a training component as described with reference to FIGS. 2 and 3. Parameters updated by the training component may include weights and biases of ANNS contained within the meta-learner machine learning model.

FIG. 10 shows an example of a method 1000 for training a meta-learner machine learning model based on a loss function according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system applies each forecasting model of a set of forecasting models to each time-series dataset of a set of time-series datasets to obtain ground-truth performance data. In some cases, the operations of this step refer to, or may be performed by, a training component as described with reference to FIGS. 2 and 3. At operation 1010, the system generates predicted performance data for the forecasting models applied to each of the time-series datasets using a meta-learner machine learning model and meta-features of the time-series datasets. In some cases, the operations of this step refer to, or may be performed by, a meta-learner machine learning model as described with reference to FIGS. 2 and 3.

At operation 1015, the system computes a loss function based on the predicted performance data and the ground-truth performance data. In some cases, the operations of this step refer to, or may be performed by, a training component as described with reference to FIGS. 2 and 3. The training component may compute loss terms, such as those described in Equations (6) and (13).

At operation 1020, the system updates parameters of the meta-learner machine learning model based on the loss function. In some cases, the operations of this step refer to, or may be performed by, a training component as described with reference to FIGS. 2 and 3.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for data processing, comprising:
receiving a time-series dataset;
computing a time-series meta-feature vector based on the time-series dataset;
generating a performance score for a forecasting model using a meta-learner machine learning model that takes the time-series meta-feature vector as input;
selecting the forecasting model from a plurality of forecasting models based on the performance score; and
generating predicted time-series data based on the time-series dataset using the selected forecasting model.

2. The method of claim 1, further comprising:
dividing the time-series dataset into a plurality of time windows; and
identifying a time window of the plurality of time windows, wherein the forecasting model is selected based on the identified time window.

3. The method of claim 1, further comprising:
computing a plurality of meta-features based on the time-series dataset; and
generating the time-series meta-feature vector based on the plurality of meta-features.

4. The method of claim 3, wherein:
the plurality of meta-features include an aggregate statistic of the time-series dataset.

5. The method of claim 3, further comprising:
performing a principal component analysis on the plurality of meta-features to obtain the time-series meta-feature vector.

6. The method of claim 1, further comprising:
generating first predicted performance data for each of the plurality of forecasting models using a time-series meta-learner of the meta-learner machine learning model, wherein the forecasting model is selected based on the first predicted performance data.

7. The method of claim 6, further comprising:
generating second predicted performance data for each of the plurality of forecasting models using a general meta-learner of the meta-learner machine learning model, wherein the forecasting model is selected based on the second predicted performance data.

8. The method of claim 7, further comprising:
providing the second predicted performance data as an input to the time-series meta-learner.

9. The method of claim 1, further comprising:
identifying a plurality of hyperparameters for each of the plurality of forecasting models; and
selecting a hyperparameter from the plurality of hyperparameters using the meta-learner machine learning model, wherein the predicted time-series data is based on the selected hyperparameter.

10. The method of claim 1, further comprising:
receiving a time-series training set; and
training the selected forecasting model based on the time-series training set, wherein the predicted time-series data is generated based on the training.

11. A method for data processing, comprising:
identifying a training set comprising a plurality of time-series datasets, a plurality of forecasting models, and ground-truth performance data for the plurality of forecasting models applied to each of the plurality of time-series datasets;
generating predicted performance data for the plurality of forecasting models applied to each of the plurality of time-series datasets using a meta-learner machine learning model;
comparing the predicted performance data to the ground-truth performance data; and
updating parameters of the meta-learner machine learning model based on the comparison.

12. The method of claim 11, further comprising:
computing a loss function based on the predicted performance data and the ground-truth performance data, wherein the parameters of the meta-learner machine learning model are based on the loss function.

13. The method of claim 12, further comprising:
computing a time-series loss term based on an output of a time-series meta-learner; and
computing a general loss term based on an output of a general meta-learner, wherein the loss function comprises the time-series loss term and the general loss term.

14. The method of claim 11, further comprising:
applying each of the plurality of forecasting models to each of the plurality of time-series datasets to obtain the ground-truth performance data.

15. The method of claim 14, further comprising:
training a forecasting model of the plurality of forecasting models on each of the plurality of time-series datasets to obtain a trained forecasting model, wherein the ground-truth performance data is based on the trained forecasting model.

16. An apparatus for data processing, comprising:
a processor;
a memory including instructions executable by the processor;
a meta-feature extraction component configured to compute a plurality of meta-features based on a time-series dataset; and
a meta-learner machine learning model configured to select a forecasting model from a plurality of forecasting models based on the time-series dataset.

17. The apparatus of claim 16, further comprising:
a training component configured to update parameters of the meta-learner machine learning model based on a loss function.

18. The apparatus of claim 16, wherein:
the meta-learner machine learning model comprises a general meta-learner and a time-series meta-learner.

19. The apparatus of claim 18, wherein:
the time-series meta-learner comprises an long short-term memory (LSTM) model.

20. The apparatus of claim 16, further comprising:
a feature-embedding component configured to reduce a dimensionality of the plurality of meta-features.
